(19) United States
(12) Patent Application Publication
(10) Pub. No.: US 2013/0309390 A1
(43) Pub. Date: Nov. 21, 2013

(54) COMBINATION ALCOHOLIC BEVERAGE AND SEPARATELY PACKAGED FLAVORANT

(71) Applicant: Seth NADEL, Morristown, NJ (US)

(72) Inventor: Seth NADEL, Morristown, NJ (US)

(21) Appl. No.: 13/896,391

(22) Filed: May 17, 2013

Related U.S. Application Data
(60) Provisional application No. 61/648,574, filed on May 17, 2012.

(51) Int. Cl. C12G 3/07; C12G 3/06

(52) U.S. Cl. CPC C12G 3/065; C12G 3/06
USPC 426/592

(57) ABSTRACT

An alcoholic beverage bottle in combination with a flavorant that can be placed within or otherwise added to the alcoholic beverage bottle, to directly contact the alcoholic beverage. The flavorant can be a solid or a liquid. The flavorant imparts a flavor to the alcoholic beverage and the time of contact with the alcoholic beverage can be controlled by the consumer so as to flavor the alcoholic beverage to suit the particular taste of the consumer. A package is included that contains the bottle filled with an alcoholic beverage along with one or more flavorants so that the consumer can select one or more of the flavorants to enhance the flavor of the alcoholic beverage. A method is provided for the consumer to add the flavorant to a bottle of alcohol beverage to allow the flavorant to contact the alcohol beverage and add flavor to the same.

### RELATED APPLICATION

The present application claims the benefit under 35 U.S.C. §119 of U.S. Provisional Application Ser. No. 61/648,574, filed May 17, 2012. The content of said provisional application is hereby incorporated by reference in its entirety.

### BACKGROUND

The present invention relates to a bottle for an alcoholic beverage and, more particularly, to a combination of a bottle and a flavorant that can be manually added or inserted into the bottle containing an alcoholic beverage to contact the alcoholic beverage and impart a flavor thereto. The flavorant of the invention may be in solid or liquid form.

It is common practice today in the production of alcoholic beverages, such as whiskey, to allow the beverage to age. During the aging process, a flavor is imparted to the whiskey through the contact between the beverage and a wood, generally oak. Such flavor enhancement may result from the contact with oak barrels or the addition of oak staves to create the flavor that is desired in whiskies.

One example of the use of wood to enhance the flavor of a whiskey is described in U.S. Pat. No. 1,976,091 to Pritchett. In Pritchett, there is described the addition of chips of wood that have been meticulously processed, into a container such as a keg of whiskey, to contact the whiskey and to reduce the amount of time of ageing and flavoring of the whiskey.

While useful, there is a difficulty in that the flavoring process of the Pritchard patent is not carried out by the consumer. As a consequence, the flavoring of the beverage by means of the wood chips is not within the control of the ultimate consumer of the alcoholic beverage; that is, the contact with the wood chips does not take place under the control of the actual consumer who may prefer to determine the amount of time that the flavorant is in contact with the alcoholic beverage in order to achieve a particular, preferred flavor of the alcoholic beverage.

Another development with alcoholic beverages concerns the preparation of flavored beverages. This is particularly popular in the instance of beverages that have a muted or purely alcoholic taste, such as a vodka and gin. In such instances, the alcoholic beverages have been prepared with flavorings such as fruit flavors, and other flavors such as vanilla and chocolate, and these have been included prior to bottling. The resulting products are sold as sealed containers, with the entire contents bearing the particular flavor that has been included.

While the consumer may enjoy the pre-flavored beverage, there may be the desire to modify the flavor to suit the taste of the individual. In the instance of whiskey, the consumer may wish to intensify or modify the flavor of the beverage, while in the instance of beverages such as vodka or gin, the consumer may wish to introduce a new flavor to an otherwise unflavored product. In both instances, the consumer may wish to modify the flavor of the particular beverage to suit individual taste.

It would therefore be advantageous to have a flavorant that could be conveniently supplied with a consumer bottle of an alcoholic beverage, such as a whiskey, or a vodka or a gin, such that the ultimate consumer could control the timing of the contact between the flavorant and the alcoholic beverage to suit the particular taste of the consumer.

### SUMMARY OF THE INVENTION

Accordingly, the present invention relates to a combination of a bottle for containing an alcoholic beverage and a flavorant in either solid or liquid form that can be used by the consumer to add flavor to the alcoholic beverage to the taste of the consumer. In a first embodiment, the flavorant may be in solid or powdered/granular form, while in an alternate embodiment, the flavorant may be a liquid.

With the present invention, the bottle has an opening for dispensing of the contents of the bottle and includes a conventional cap that normally seals the opening, and that can be removed by the consumer when desired in order to access the contents of the bottle through the opening.

A flavorant is included that is in either solid or liquid form. The flavorant can be prepared from or can contain a variety of materials that impart a particular flavor to the alcoholic beverage by contact therewith. In the instance of the solid form, the flavorant may be a segment of naturally flavored plant material or the like, including certain tree woods, such as oak, for whiskey, and cherry wood, vanilla or cocoa beans, for beverages such as vodka and gin. Such solid flavorants can be disposed either directly, or within a porous dispenser, so the flavorants will come into contact with the beverage when immersed therein. In the instance where the flavorant is in liquid form, it may be disposed in a small vial or bottle, that is packaged and sealed, and removably attached as by a tether, to the bottle containing the alcoholic beverage. In another embodiment, the flavorant and the beverage may be packaged in a container that houses both components. In practice, the vial or bottle containing the flavorant may be opened and the contents poured into the larger bottle containing the unflavored beverage.

The flavorant can be affixed to the bottle by means of a tether that can be flexible to allow the flavorant to be grasped by the user and added to the contents of the bottle through the opening, as described above. As described, the flavorant comes in contact with the alcoholic beverage and will thereby impart a particular flavor thereto.

The flavorant may be directly affixed to the bottle by means of the tether or can, itself, be supplied within a container and thus removed from that container prior to insertion of the flavorant into the bottle. The container may have a sealed chamber, or may be a bag or other device to hold the flavorant.

Further, the alcoholic beverage can be provided in a package that contains not only the bottle of the alcoholic beverage but may also contain one or more flavorant units within the package so that the user can add the flavorant to the alcoholic beverage and, if multiple flavor units having different flavors are supplied in the package, the consumer can select one or more of the respective flavor units to suit the taste of the consumer.

Lastly, the present invention includes a method of flavoring an alcoholic beverage wherein the consumer can open the bottle of an alcoholic beverage and insert a particular flavorant into the beverage to modify the flavor of the bottle contents. In the instance of the solid flavorant, it can be retained in contact with the bottle contents for a period of time controlled by the consumer so that the ultimate alcoholic beverage has the strength or level of flavor that suits the taste of the consumer.

These and other improvements and features of the present invention will become better understood from the detailed description of the preferred embodiment set forth below taken in conjunction with the accompanying drawings.

### BRIEF DESCRIPTION OF THE DRAWINGS

FIG. 1 is a front view illustrating the bottle of the present invention containing an alcoholic beverage and including a flavorant affixed thereto;

FIG. 2 is a front view of the bottle of FIG. 1 with the flavorant contained within the bottle in contact with the alcoholic beverage; and

FIG. 3 is a top view of a package containing the components for carrying out the present invention.

### DETAILED DESCRIPTION OF THE INVENTION

Referring now to FIG. 1, there is shown, a front view of a bottle 10 of the present invention. The bottle has a removable cap 12 that can be conventional and may be threadedly affixed to the bottle 10 such as at the top of a neck 14 thereof, which neck 14 may be elongated as shown. Accordingly, the cap 12 normally seals an opening 16 in neck 14 of the bottle 10 and the removable cap 12 can be removed to access the contents of the bottle 10.

The bottle 10 contains an alcoholic beverage 18 and the alcoholic beverage 18 may be any of a variety of beverage that may include, but is not limited to, rye whiskey, scotch whiskey, bourbon, gin, vodka, wine, or beer.

Attached to the bottle 10 is a sealed container 20 that may be plastic or other inexpensive material and which may have a closed bottom 22 and an open top 24 that is closed by a removable sealing member 26 so as form a closed chamber 28 within the sealed container 20. The sealing member 26 is removable from the open top 24 of the sealed container 20 to provide access to the interior of the closed chamber 28.

As contemplated and included herein, the sealed container 20 may also be prepared in other configurations and constructions, including a bag or other flexible container.

Accordingly, a flavorant 30 is provided within the sealed container 20. In a first embodiment, the flavorant 30 is comprised of a solid material that adds flavor to an alcoholic beverage 18 when the solid flavorant 30 comes in contact with the alcoholic beverage 18. As such, the solid flavorant 30 can be a wood or wood derivative such as charcoal or burned wood, or a solid material that can add a specific desired flavor to an alcoholic beverage such as a vodka or a gin, for example, by adding a vanilla or a chocolate flavor, or other specialty flavor to the vodka or gin.

Solid flavorants may be prepared and include liquid flavorants that have been introduced into a porous material such as a fiber material, and then dried to form the solid flavor dispenser. Alternately, the flavor may be prepared as a solid, granular material that is packaged within a flexible porous cachet or bag, such as a tea bag, and that can be introduced into the beverage bottle and allowed to soak or steep therein to release the flavor.

Liquid flavorants may be juice concentrates or fruit extracts, or the like, that are packaged in small bottles with removable caps, not shown, or are sealed within soluble capsules or containers. In either event, the contents of the flavorant dose will be introduced into the beverage bottle and the contents will be released to mix therewith, to impart the intended flavor thereto.

The sealed container 20 is, in the exemplary embodiment, affixed to the bottle 10 by means of a tether 32. In the embodiment illustrated in the figures herein, tether 32 may be a flexible member that is affixed to neck 14 and to the sealed container 20 so that the sealed container 20 is conveniently affixed to the bottle 10 and is thus readily available to the consumer of the alcoholic beverage 18 within the bottle 10.

In an alternative exemplary embodiment, a tether 32′, shown in dotted lines in FIG. 1, can be directly attached to the flavorant 30 such that, as will later become clear, the flavorant 30 can be used in accordance with the present invention and the tether 32′ can remain attached to both the bottle 10 and the flavorant 30 during such use.

As used herein, the term “tether” includes the flexible member illustrated at 32 and 32′, as well as other, less flexible or more fixed means of attachment extending between the bottle 18 and the vial or container 20. For example, a collar-like member may be used that has openings respectively sized, for example, to receive and rest on the neck 14 of the bottle 18, and to releasably retain the container 20. Such member would be present to retain a bottle 18 and container 20 as a unit during shipping and before use, and could be fabricated from a variety of materials, such as cardboard and the like. In use, the container 20 would be removed from the member and the member, in turn, would be removed from the neck of the bottle 18, leaving the container 20 freestanding for use by the consumer.

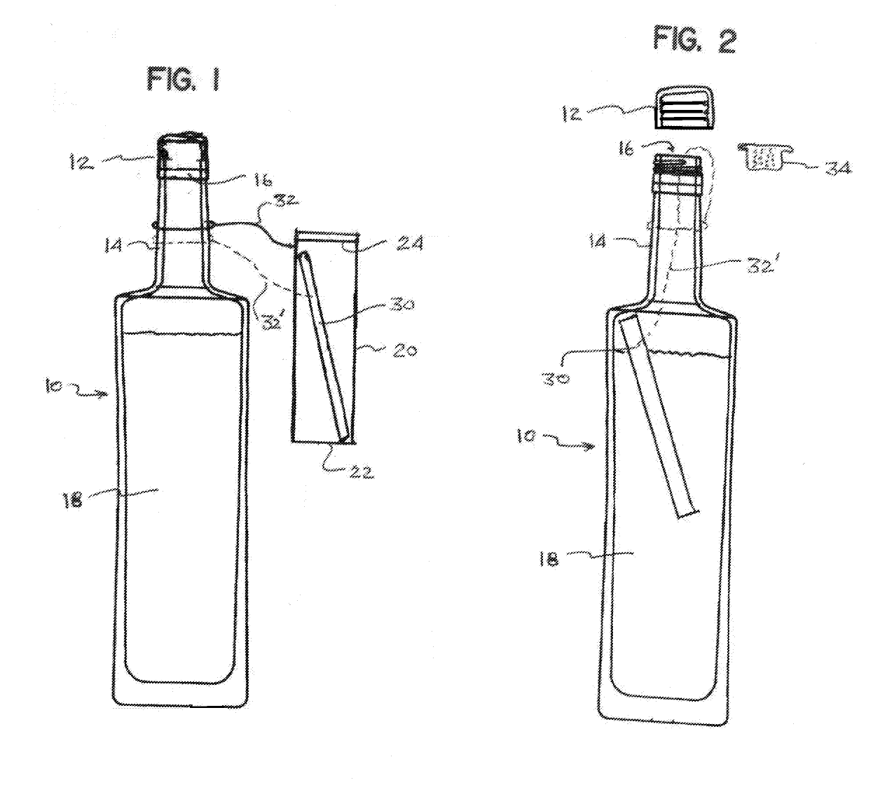

Turning now to FIG. 2, there is shown a front view of the present invention, wherein the flavorant 30 has been placed by the consumer inside the bottle 10 so as to be in direct contact with the alcoholic beverage 18.

As such, the cap 12 has been removed and the flavorant 30 is dimensioned so as to be suitable for inserting the flavorant 30 through the opening 16 and into the bottle 10.

In the embodiment where the tether 32′ is affixed directly to the flavorant 30, it can be seen that the tether 32′ can remain affixed to the flavorant 30 so that the user can use the tether 32′ to remove the flavorant 30 from the bottle 10, after a sufficient time has been allowed to pass for the flavorant 30 to contact the alcoholic beverage 18 to achieve the desired flavor.

In such embodiment, it clearly necessary for the length of the tether 32′ to extend from its point of affixation to the bottle 10 through the opening 16 and into the interior of the bottle 10, where the flavorant 30 can contact the alcoholic beverage 18.

As a further feature of the present invention, there can also be a filter 34 that can be inserted into the opening 16 after the cap 12 has been removed. The purpose of the filter 34 is to trap any particulate material or sediment, such as wood particles, that may have separated or disengaged from the flavorant 30, so that the consumer can pour the contents from the bottle 10 without encountering any sediment in the alcoholic beverage 18 dispensed from the bottle 10.

The method of the present invention can now be described with reference to FIGS. 1 and 2. The consumer acquires the bottle 10 filled with an alcoholic beverage 18 with the flavorant 30 that may be affixed thereto by means of the tether 32, either in the sealed container 20 of FIG. 1, or directly affixed by a tether 32′ to the bottle 10. Alternatively, the flavorant 30 can provided in a package along with the bottle 10, or even acquired separately.

The consumer can then remove the cap 12 and insert the flavorant 30 into the bottle 10 through the opening 16 so that the flavorant 30 comes in contact with the alcoholic beverage 18. At this point, the consumer can control the amount of time that the flavorant 30 is in contact with the alcoholic beverage 18 and thus control the ultimate extent of flavoring of the alcoholic beverage 18 imparted thereto by the flavorant 30. Obviously, if the consumer desires a stronger flavor imparted to the alcoholic beverage 18, the flavorant 30 would be left in contact with the alcoholic beverage 18 for a greater period of time.

When the amount of time desired by the consumer has elapsed, the flavorant 30 can be removed from the bottle 10 so that the flavor of the alcoholic beverage 18 stays the same for further consumption thereof of the alcoholic beverage 18 from the bottle 10.

In the instance where the flavorant 30 is a liquid, it can simply be poured into the container holding the alcoholic beverage 18. In practice, the consumer can pour all or part of the contents of the flavorant into the bottle holding the alcoholic beverage. As an alternate embodiment, not illustrated, the container holding the liquid flavorant may be calibrated as to volume or the like, to guide the consumer seeking to control the amount of flavorant added.

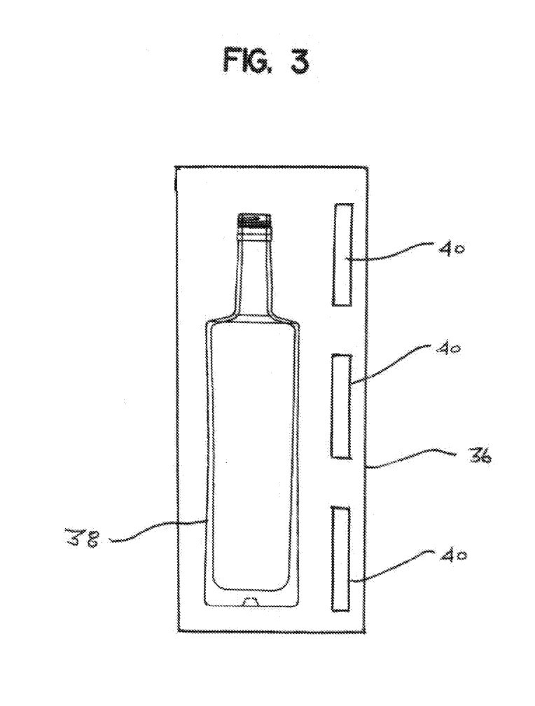

Finally, turning to FIG. 3, there is shown a package 36 that can be used to provide the features of the present invention to a consumer, which package 36 includes a bottle 38 containing an alcoholic beverage. Alongside the bottle 38 are one or more flavorants 40, including both solid and liquid flavorants, that can be used to contact the alcoholic beverage within the bottle 38 to impart a particular flavor to the alcoholic beverage. If a plurality of flavorants 40 is present, each can be a different flavor so that the user can select one or more of the flavorants 40 from the plurality of flavorants 40 provided, to flavor the alcoholic beverage to taste.

While the exemplary embodiment shows a box as the package 36, it can be seen that the package 36 can be any container for the bottle 38, such as a flexible bag or other container.

Those skilled in the art will readily recognize numerous adaptations and modifications which can be made to the combination of a bottle and flavorant and method of flavoring an alcoholic beverage using a solid flavorant which will result in an improved flavored alcoholic beverage, yet all of which will fall within the scope and spirit of the present invention as defined in the following claims Accordingly, the invention is to be limited only by the following claims and their equivalents.

1. A combination of a bottle containing an alcoholic beverage and a flavorant, the bottle having an opening for dispensing the alcoholic beverage and a removable cap for closing the opening, the flavorant adapted to provide a flavor to the alcoholic beverage by contact therewith, and a tether affixing the flavorant to the bottle.

2. The combination as defined in claim 1 wherein the flavorant is selected from a solid flavorant, a powdered flavorant and a liquid flavorant.

3. The combination as defined in claim 2 wherein the flavorant is a solid.

4. The combination as defined in claim 3 wherein the flavorant is a wood or wood derivative product.

5. The combination as defined in claim 1 wherein the alcoholic beverage is selected from a distilled whiskey, and vodka.

6. The combination as defined in claim 3 wherein the flavorant is disposed in a separate container.

7. The combination as defined in claim 1 wherein the tether is selected from a flexible member and a fixed member having means for attachment to said bottle and to said flavorant.

8. The combination as defined in claim 7 wherein the flexible member is of sufficient length to allow the flavorant to be introduced through the opening in the bottle and to contact the alcoholic beverage contained within the bottle.

9. The combination as defined in claim 1 further comprising a filter that covers the opening to prevent the flavorant or sediment from the flavorant to pass through the opening.

10. The combination as defined in claim 1 wherein the flavorant is contained within a sealed container external of the bottle.

11. A package for providing an alcoholic beverage to a consumer, the package comprising an enclosure having contained therein a bottle of an alcoholic beverage, the bottle having an opening for dispensing the alcoholic beverage and a cap for closing the opening, the package further containing at least one flavorant for introduction into the bottle through the opening to flavor the alcoholic beverage contained therein.

12. The package as defined in claim 11 wherein the at least one flavorant is selected from a solid, a liquid and mixtures thereof

13. The package as defined in claim 11 wherein the at least one flavorant comprises a plurality of flavorants providing differing flavors to the alcoholic beverage contained within the bottle.

14. The package as defined in claim 13 wherein the plurality of flavorants are solids and comprise differing wood or wood derivative products.

15. The package as defined in claim 11 wherein the at least one flavorant is affixed to the bottle containing said alcoholic beverage.

16. A method of flavoring an alcoholic beverage comprising the steps of:
providing a bottle containing the alcoholic beverage, the bottle having an opening for dispensing the alcoholic beverage and a removable cap for closing the opening;
removing the cap to open the opening of the bottle;
introducing a flavorant into the bottle through the opening to contact the alcoholic beverage; and
allowing the flavorant to remain in contact with the alcoholic beverage for a predetermined time.

17. The method as defined in claim 16 wherein the step of providing a bottle comprises providing a bottle having said flavorant affixed to the bottle.

18. The method as defined in claim 16 wherein the flavorant is selected from a solid flavorant and a liquid flavorant.

19. The method of claim 17 wherein the step of providing a bottle comprises providing a bottle having said flavorant affixed to the bottle by means of a tether.

20. The method of claim 19 wherein the tether is a fixed member with means for retaining said bottle and said flavorant.
